(19) United States
(12) Patent Application Publication
(10) Pub. No.: US 2015/0132190 A1
(43) Pub. Date: May 14, 2015

(54) END RING RETENTION OF METAL CATALYST SUBSTRATES

(71) Applicant: ACAT Global, Charlevoix, MI (US)

(72) Inventor: Joseph A. Moch, Laguna Beach, CA (US)

(73) Assignee: ACAT Global, Charlevoix, MI (US)

(21) Appl. No.: 14/077,779

(22) Filed: Nov. 12, 2013

(51) Int. Cl. B01D 53/94

(52) U.S. Cl. CPC B01D 53/94
USPC 422/168; 422/311

(57) ABSTRACT

An end ring assembly is used to create catalytic converter assemblies. The end segments have a length and a sidewall extending substantially the length of each segment, and a front face wall intersecting said sidewall and extending at least a portion of said length. At least one segment has retention barb projections positioned along its length to pierce the catalytic converter substrate and retain the ring segment in place. The ring segment is assembled using welding techniques to create a catalytic converter assembly.

### RELATED APPLICATIONS

This application claims priority to U.S. Provisional App. No. 61/725,130 filed on Nov. 12, 2012, which is hereby incorporated by reference in its entirety.

### TECHNICAL FIELD

Net Shape Capacitive Discharge welding is used to secure metal foil layers together to form various catalyst substrate shapes. This process was developed to replace controlled atmosphere furnace brazing as the typical metal catalyst substrate assembly technique. A Capacitive Discharge welding process reduces the assembly processing time for securing a metal substrate together from hours to less than a minute. To achieve maximum as-welded strengths, a half substrate manufacturing technique is used. For subsequent wash coat and canning operations, a method to secure these as-welded half substrates together into a final substrate assembly is required. The assembly method employed must be adaptable for various shapes and sizes of metal substrates while insuring a robust final assembly capable of functioning in an exhaust catalyzing environment.

Welded half substrates joined together into a final substrate assembly may provide adequate substrate strength for wash coating operations. However, in order to avoid the use of a ceramic mat material during substrate canning operations, additional assembled rigidity is required. The use of perimeter end rings provides the additional strength required for subsequent mat-less canning techniques. Whereas, it is known in U.S. Pat. No. 5,051,294 to use a clam-shell canning method, the present disclosure has expanded the use of a perimeter end ringed metal substrate assembly to additionally include both direct to mantle and spin-formed canning techniques. All of these canning methods avoid the use of a ceramic mat to provide sealing and cushioning functions. The present disclosure uses perimeter end-rings to increase the strength and robustness of the metal substrate in operation and to provide a structural feature allowing for multiple canning techniques.

### SUMMARY

In one embodiment, the present disclosure relates to the use of stainless steel end rings specifically for use in the assembly of Capacitive Discharge (CD) welded half substrates into a final substrate assembly. The end ring operation occurs after the as-welded half substrates have been oxidized in a heat treating operation designed to grow specific high surface area oxide morphology. The end rings are designed to match the profile of each welded half. A total of four end rings—two per each substrate end face (typically designated front face and back face) are used to complete a final substrate assembly. The end rings are designed to allow for a specific amount of compression to occur between the two substrate halves as they are brought together. The substrate assembly is completed when the contact areas of the butted end rings are MIG welded together. The assembly fixtures are designed to be used as an upper and lower unit. Features common to each fixture include the ability to locate and secure each end ring (front face and back face) into position thus allowing for accurate loading of the as-welded/oxidized half substrates securely in place.

### BRIEF DESCRIPTION OF THE DRAWINGS

Features and advantages of the present disclosure will become more apparent from the following detailed description of exemplary embodiment thereof taken in conjunction with the accompanying drawings in which:

FIG. 1 is a perspective top view of exemplary retention end ring segments showing retention barbs prior to assembly into an end ring;

FIG. 2 is a perspective top view of ring segments to be joined with the ring segments of FIG. 1 to create an assembled end ring;

FIG. 3 is a perspective top view of a an end ring assembled of the segments seen in FIGS. 1 and 2;

FIG. 4 is another embodiment of a barbed end ring according to another embodiment;

FIG. 5 is an oval substrate assembly of a catalytic converter with the end rings in place on the ends of the substrate;

FIG. 6 is another round substrate assembly of a catalytic converter with end rings in place on the ends of the substrate;

### DETAILED DESCRIPTION

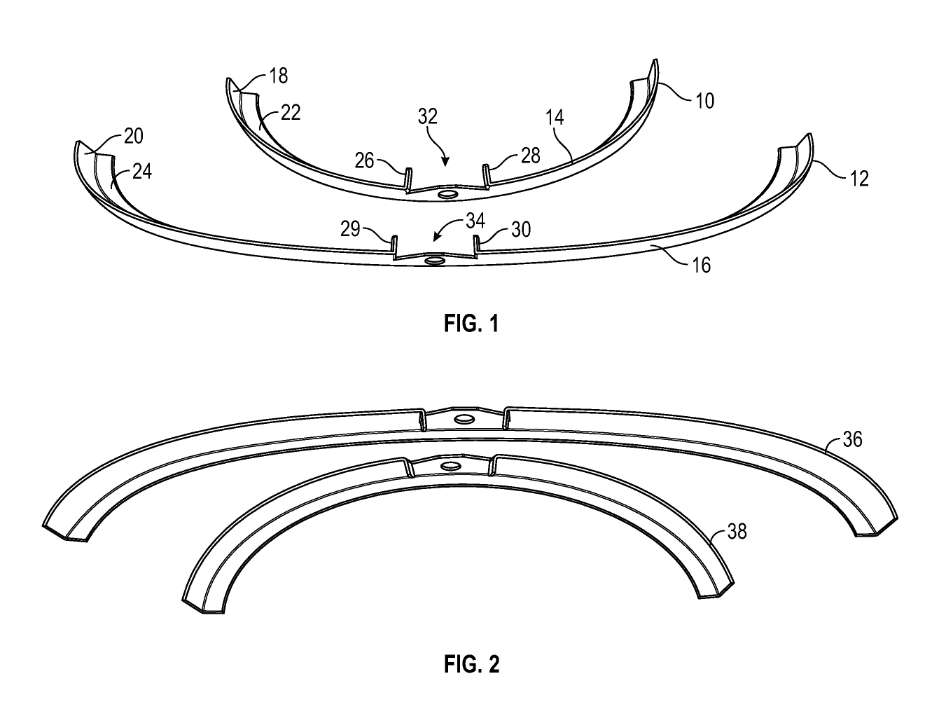

Turning now to the drawings wherein like numbers refer to like structures, FIG. 1 is a perspective top view of first segment 10 and second segment 12, of an exemplary modular end ring structure for use in the assembly of CD welded half substrates into a fully assembled substrate. In this example, each of end ring segment 10 and 12 has a body portion 14 and 16, respectively, having sidewalls 18 and 20 that intersect with end face wall 22 and 24, respectively. Each segment 10 and 12 is further equipped with retention barbs 26, 28 on ring segment 10, and retention barb projections 29, 30 on the segment 12, to assist retaining the ring in place on the assembled substrate. The ring segments may be made of any suitable metal, such as, for example, stainless steel, or any other metal that is suitable for welding processes.

A feature of the exemplary end ring design is the incorporation of the retention barb projections located in the central section 32, 34, respectively of each end ring segment 10 and 12. It will be appreciated that while they are depicted as being centrally located on the ring segment any location of barbs on the rings may be selected that is advantageous in securing the end ring in place on the substrate assembly. These projections act initially as a locking feature to help secure each half substrate into proper alignment during assembly. Upon completion of the compression and MIG welding operations the projections then act as a front and back face locking mechanism for each assembled half substrate.

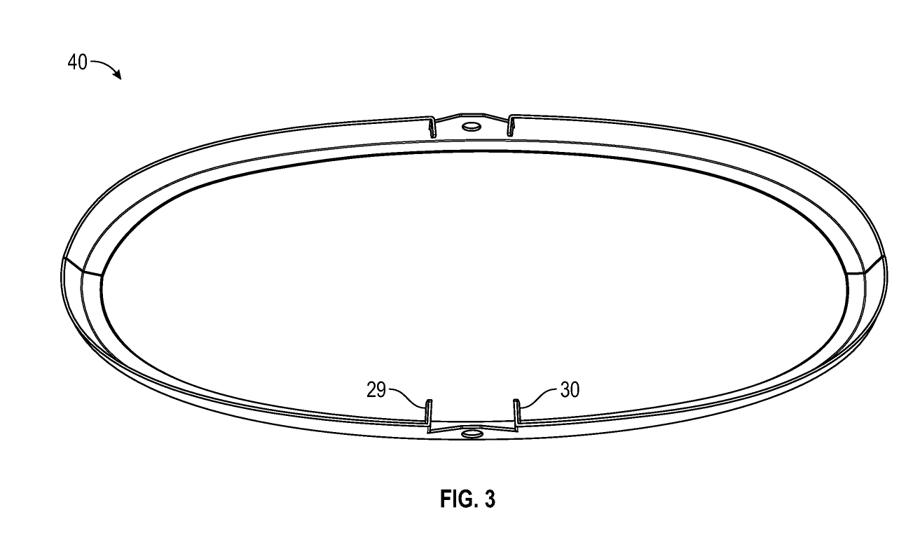

FIG. 2 is a perspective top view of two end ring segments 36 and 38, that when joined with ring segments 10 and 12, form a completely assembled end cap ring structure 40, as seen in FIG. 3, which is the assembly of ring segment 12 with ring segment 36. It is to be understood that the assembly of ring segment 10 with ring segment 38 would create a similar structure, but the shape would be somewhat less elongated than the ring end cap assembly of FIG. 2.

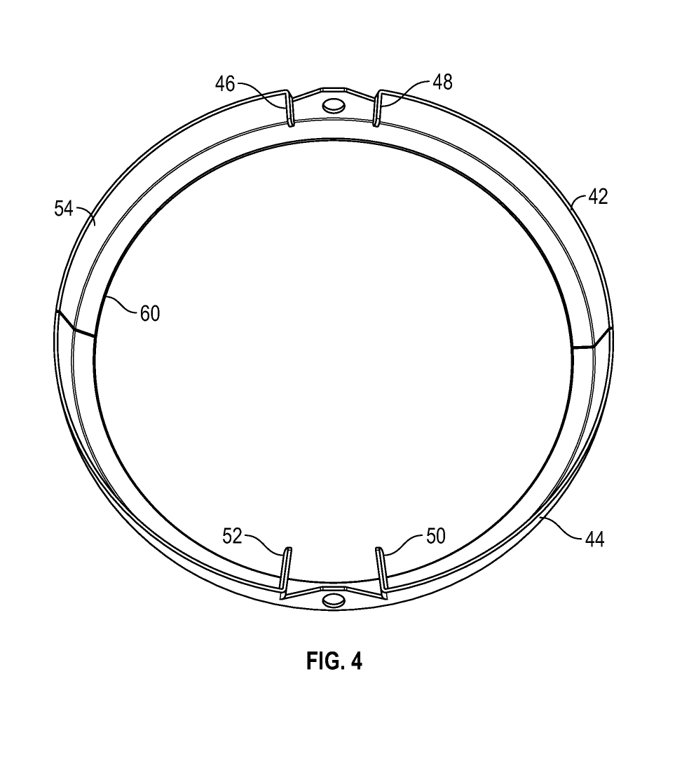

FIG. 4 shows another embodiment of the ring segments in the present disclosure, wherein each ring segment has retention barb projections. In this embodiment, ring segment 42 and 44 each have retention barbs 46, 48, 50 and 52 respectively, centrally located on the ring respective segment. In this embodiment, the ring segments, when joined together, form a circular end cap ring, as seen in FIG. 4. The construction of the ring segments in this embodiment is similar to that discussed above, with a sidewall 54 intersecting a face wall 60. It is understood that the ring segment may be of any shape, and the shape is determined by the shape of the substrate to which the end ring with be placed.

Reviewing FIGS. 1-4, it can be readily understood that a second key feature of the end cap assembly is the front face wall of the end ring. This feature is dimensionally controlled to provide face support and edge protection to each substrate half while minimizing blockage of the active surface area. Protection of the stacked foil layer edges along the perimeter of the as-welded halves may prevent or reduce damage during canning operations.

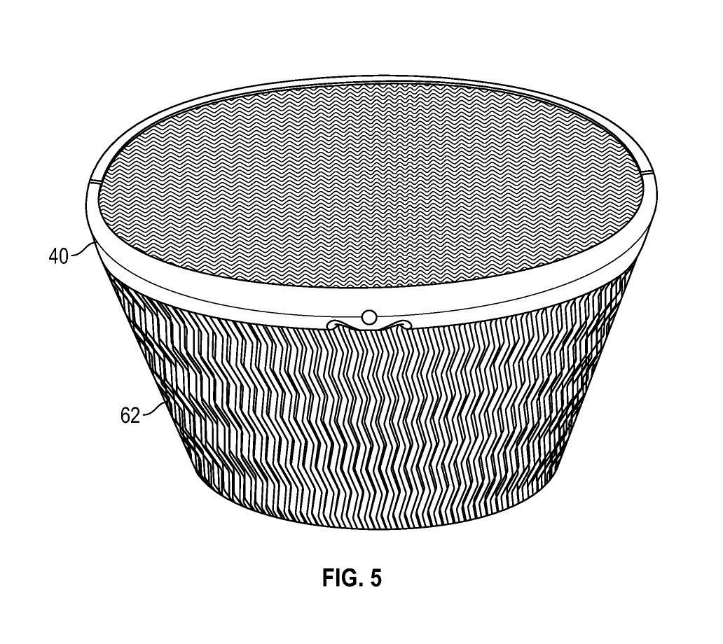

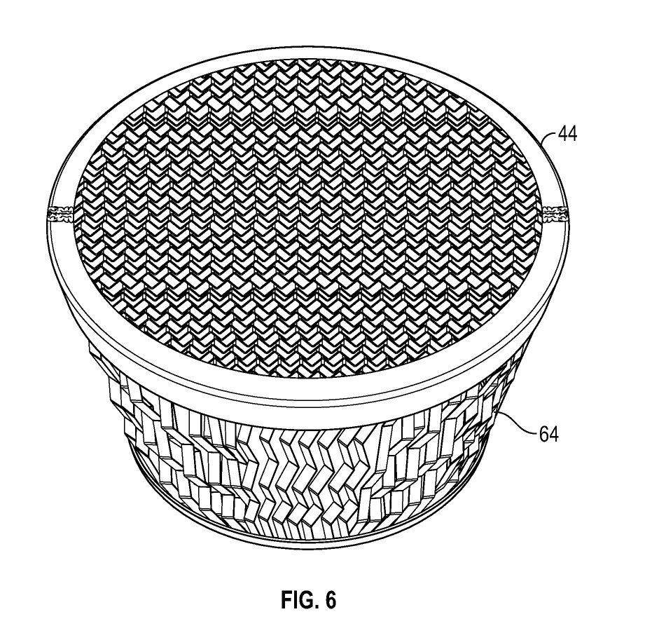

FIGS. 5 and 6 show the end rings 40, 42 in place over a substrates 62, 64, respectively such a corrugated steel sheets, which may be of any high temperature material, and formed to provide a great many number of gas passages. The substrates are formed of “half substrates” that may be assembled through CD discharge welding processes. The substrate may then be oxidized in a heat treating operation intended to grow specific high surface area oxide morphology. The substrates so formed are thereby prepared to receive the assembled end cap rings.

When the end cap ring segments are to be assembled into rings, they are placed into contact with the prepared substrates such that the barbs pierce the substrates and locked the ring in place. The ring is secured to the substrate by welding, such as MIG welding, or any other welding method sufficient to affix the end ring in place.

The end ring segments are welded together using CD welding processes. Previous metal substrate profiles considered suitable for the CD welding process were typically limited to low aspect ratio profiles such as rectangles, cubes and racetracks. As stated, in one embodiment, the present disclosure provides for a CD welded and end ring assembly process that includes round and short-aspect-ratio oval profiles. An advantage of this process is to create a cost effective, stable and robust thin metal foil catalyst assembly. The process is flexible to a wide range of shape and size combinations. Costly and time consuming atmosphere furnace brazing operations typically used with thin metal substrate assemblies are reduced or eliminated. In addition, the end ring process creates a physical feature that may be further utilized as a structural element during canning operations. The barb shaped projections incorporated in the end ring designs of the present disclosure may act as an assembly aid while providing additional locking strength between the CD welded halves creating each assembly.

While several embodiments have been described, it is understood by those skilled in the art that the words used in such description are not limiting in any way. Many variations and modifications are possible without departing from the scope and spirit of the invention. For example, with regard to the systems and methods described herein, it should be understood that, although certain steps of the methods have been described as occurring in a certain order, such methods could be practiced in a with the steps performed in a different order. Certain steps could be performed simultaneously, other steps could be added, and that certain steps could be omitted. In other words, the descriptions of methods are provided to illustrate certain embodiments, and should not be interpreted to limit the claimed inventions.

Similarly, the above description is not intended to be restrictive. The scope of the invention should be determined with reference to the appended claims, along with the full scope of equivalents. It is expected that future developments will occur, and that the disclosed systems and methods will be incorporated into such future embodiments.

All terms used in the claims are to be given their broadest reasonable constructions consistent with their ordinary meanings as understood by those knowledgeable in the technologies described herein unless expressly indicated otherwise.

Use of the singular articles such as “a,” “the,” “said,” etc. should be read to recite one or more of the identified elements unless a claim recites expressly indicates otherwise. The terms “one example” or the like mean that a feature described affiliated with the example is included in at least one example. The terms “in one example” in different places in the specification does not necessarily refer to the same example.

What is claimed as new and desired to be protected by Letters Patent of the United States is:

1. An end cap ring assembly, comprising:
a first segment having a length and width, and a second segment having a length and width;
each said segment having a sidewall extending substantially along the length of said segment, each segment further having a face wall intersecting said sidewall along at least a portion of said length; and
retention barb projections on at least one said segment each said segment adapted to be joined to another segment to form an end cap ring.

2. A catalytic converter substrate assembly, comprising:
a first and second half substrate secured together to form a whole substrate;
each substrate having a great number of gas flow through passages;
ring segments conforming to substrate contour and attached to each substrate;
each ring segment having a length and a sidewall extending substantially along said length, and a face wall intersecting said sidewall along at least a portion of said length;
at least one ring segment having at least one retention barb projection located along its length;
said barb retention projection capable of piercing said substrate to locate said segment; and
said segments welded together to form an end ring on said substrate to create the catalytic converter assembly.
